(19) United States
(12) Patent Application Publication
(10) Pub. No.: US 2021/0316654 A1
(43) Pub. Date: Oct. 14, 2021

(54) Control System and Control Method for Adapting the Reproduction of Visual Signals for a Vehicle Having a Hybrid Drive

(71) Applicant: Bayerische Motoren Werke Aktiengesellschaft, Muenchen (DE)

(72) Inventors: Paolo IOCCO, Muenchen (DE); Nicolay RUFFO, Unterschleissheim (DE)

(21) Appl. No.: 17/285,300

(22) PCT Filed: Nov. 5, 2019
(86) PCT No.: PCT/EP2019/080199

§ 371 Date: Apr. 14, 2021

(30) Foreign Application Priority Data
Nov. 14, 2018 (DE) 10 2018 128 565.5

(51) Int. Cl. B60Q 3/16; B60K 35/00

(52) U.S. Cl. CPC B60Q 3/16; B60K 35/00; B60K 2370/172; B60K 2370/178; B60K 2370/166; B60K 2370/164; B60Y 2200/92

(57) ABSTRACT

A control system for adapting a reproduction of visual signals for a vehicle having a hybrid drive. The control system includes a sensor, which is designed to sense the operating mode of an internal combustion engine and of an electric drive device of the vehicle and an electronic control unit. The electronic control unit is coupled to the sensor and is designed to adapt the reproduction of a visual signal in accordance with the sensed operating modes of the internal combustion engine and of the electric drive.

### BACKGROUND AND SUMMARY OF THE INVENTION

The present subject matter relates to a control system and to a control method for adapting the reproduction of visual signals for a vehicle having a hybrid drive and to a control method for adapting the reproduction of visual signals for a vehicle having a hybrid drive.

A hybrid drive usually has two different energy converters, e.g., an internal combustion engine and an electric motor.

In a hybrid vehicle, it may be the case that the vehicle occupants, in particular the driver, are not clear as to which operating mode (drive by means of the internal combustion engine or by the electric motor) the vehicle is in. In situations in which rapid switching over from the one operating mode to the other is necessary, such as for example when entering an environmental zone, it would, however, be useful if the occupants were informed in a simple way about the respective operating mode.

It is therefore an object of the present subject matter to inform the vehicle occupants about the respective operating mode.

An aspect of the present subject matter relates to a control system for adapting the reproduction of visual signals for a vehicle having a hybrid drive, wherein the control system has a sensor which is configured to sense an operating mode of an internal combustion engine and of an electric drive of the vehicle and an electronic control unit which is coupled to the sensor and is configured to adapt the reproduction of a visual signal in accordance with the sensed operating modes of the internal combustion engine and the electric drive device.

An aspect of the present subject matter relates to a control method for adapting the reproduction of visual signals for a vehicle having a hybrid drive, wherein the control method comprises sensing an operating mode of an internal combustion engine and of an electric drive device of the vehicle and adapting the reproduction of a visual signal in accordance with the sensed operating modes of the internal combustion engine and of the electric drive device.

A vehicle in the sense of the present document is to be understood as any type of vehicle with which passengers and/or goods can be transported. Possible examples of this are: motor vehicles, trucks, land vehicles, buses, driver's cabs, cable cars, elevator cars, rail vehicles, watercraft (e.g. ships, boats, submarines, diving bells, hovercraft, hydrofoils), aircraft (airplanes, helicopters, ground effect vehicles, airships, balloons).

The vehicle is preferably a motor vehicle. A motor vehicle in this sense is a land vehicle which is moved by machine force without being bound to rail tracks. A motor vehicle in this sense comprises an automobile, a motorcycle, and a tractor.

In hybrid vehicles, there is a division into different categories, wherein the category depends on the portion of the overall power of the vehicle which is made up by the electric drive. Hybrid categories are, for example, the mild hybrid and the full hybrid. In the case of mild hybrid vehicles, the electric drive device assists the internal combustion engine in increasing the power. In full hybrid vehicles, it is also possible to drive without an internal combustion engine, that is to say only with the electric drive device. The method according to the present subject matter can be used completely independently of the type of hybrid.

Basically, a hybrid vehicle characterizes the presence of two different energy converters. However, in the case of what is referred to as the microhybrid, this is the case only to a conditional degree. Microhybrid vehicles have an automatic start/stop system and a braking energy recuperation system for charging a small starter battery. However, the electric machine is not used to drive the vehicle. Nevertheless, the method according to the present subject matter can also be used in microhybrid vehicles.

The control system has a sensor which is configured to sense an operating mode of an internal combustion engine and of an electric drive device of the vehicle. The term sensing of the operating mode of the internal combustion engine or of the electric drive device is understood to mean that it is sensed whether the internal combustion engine and/or the electric drive device are/is switched to the active (operational) or inactive states. In particular, it is sensed what portion of the internal combustion engine or of the electric drive device drives the vehicle. For example, the internal combustion engine can be 100% active and the electric drive device 0% active; for example, the internal combustion engine and the electric drive device can each be 50% active; for example, the internal combustion engine can be 0% active and the electric drive device 100% active. Of course, all intermediate forms of operating modes of the internal combustion engine and of the electric drive device between the abovementioned examples are also possible, that is to say the internal combustion engine can be 60% active, and the electric drive device can be 40% active.

The reproduction of the at least one visual signal is then adapted in accordance with the sensed operating modes of the internal combustion engine and of the electric drive device.

The term coupling is to be understood within the scope of the present document as meaning a communicative connection. The communicative connection can be wireless (e.g. Bluetooth®, WLAN, mobile radio) or wired (e.g. by means of a USB interface, data cable, etc.).

A visual signal in the sense of the present document can be any signal which can be perceived visually by a vehicle occupant. A visual signal in the sense of the present document comprises any display in the vehicle. Such a visual signal can be an indication of an operating state of a vehicle device or of a system of the vehicle, an indication of an operating state of the vehicle, a vehicle lighting system, instrument lighting system and/or a warning signal.

The proposed control system permits reproduction of visual signals which is clearly adapted to the operating mode when the internal combustion engine is not operational, or only the electric drive is operational or a mixed form is active. The switching over occurs here in an automated fashion on the basis of the detected operating mode of the two drive units, without the driver having to intervene manually. If the vehicle moves, for example, with a running internal combustion engine toward an intersection, the passenger compartment of the vehicle (ambient lighting) remains illuminated by means of a color scheme (e.g. orange-red) which has been configured by the driver or a vehicle system. If the internal combustion engine is switched off by means of an automatic start/stop system when it stops at the intersection (e.g. red traffic light), the color scheme is changed (e.g. to blue). If the vehicle then drives away again and if the internal combustion engine is switched on again, the color scheme is set again to the previous configuration (e.g. orange-red).

According to an embodiment, which can be combined with any of the embodiments described herein, the visual signal comprises at least one of the following: an indication of the current driving experience mode, vehicle passenger compartment lighting, warning signal, navigation display, infotainment display, road sign detection display, steering wheel lighting, combination instrument display, keypad lighting, status display of a driving assistance system and parking distance indication.

A driving experience mode can be a sport mode, comfort mode, eco mode, off-road mode or the like.

The vehicle passenger compartment lighting can relate, for example, to ambient lighting, paneling lighting, dashboard lighting or the like.

A warning signal can be, for example, a seatbelt warning signal, warning signal owing to a low external temperature, warning signal owing to an opened vehicle door, warning signal owing to a high speed or warning signal owing to the exceeding of a speed.

The term “infotainment system” is understood in the present document to refer to an operator electronic control unit which comprises a plurality of functions which relate to information and/or entertainment. Such functions relate to the following devices: car radio, navigation system, hands-free device, on-board computer, driving data display, air-conditioning system, driver assistance systems. The infotainment display is, in particular, the infotainment lighting.

The term “combination instrument” is understood in the present document to mean an operator electronic control unit which comprises displays and/or functions which relate, inter alia, to the following: tachometer, kilometer counter, rotational speed meter, fuel tank display, coolant temperature display, control lights and direction of travel indicator. The combination instrument comprises, for example, a heads-up display. The combination instrument display is, in particular, the combination instrument lighting.

The infotainment system and the combination instrument have different interfaces to one or more of the following: one or more control devices, external devices, preferably electronic terminals, storage media, data sources, computing unit.

According to an embodiment which can be combined with any of the embodiments described herein, the adaptation of the reproduction of the at least one visual signal comprises changing at least one of the following properties of the at least one visual signal: intensity, brightness, color, color sequence, color nuance, flashing frequency.

According to an embodiment which can be combined with any of the embodiments described herein, at least one of the properties of the at least one visual signal is adapted in the following way if the internal combustion engine is operational in addition to the electric drive device or alone: increasing or reducing the intensity; increasing or reducing the brightness; changing the color; changing the color sequence; changing the color nuance; and increasing or reducing the flashing frequency.

Such adaptations bring about a gain in comfort because as a result a vehicle occupant intuitively experiences the connection or the activity of the internal combustion engine without being distracted in the process from his actual activity, such as for example the driving task. For example, an eco-mode is made apparent to the vehicle occupants as a current driving experience mode by means of green display lighting (e.g. heads-up display, combination instrument, ambient lighting and/or infotainment system) with low intensity. If the internal combustion engine is then connected, the intensity of the green display lighting changes to an intensity. The changing of the color intensity of the display lighting brings about an appropriate sensation in the vehicle occupants without them being unnecessarily disturbed or distracted.

According to an embodiment which can be combined with any of the embodiments described herein, the control system also has an individual sensor which is coupled to the electronic control unit and is configured to sense at least one individual parameter (32) which is assigned to a vehicle occupant. The electronic control unit is also configured to adapt the reproduction of the visual signal also in accordance with the at least one individual parameter (FID1, . . . , FIDn) of the vehicle occupant.

The vehicle occupant is, in particular, the driver of the vehicle.

According to an embodiment which can be combined with any of the embodiments described herein, the at least one individual parameter is suitable for defining the adaptation of the reproduction of the visual signal and for adding to or replacing the adaptation in accordance with the sensed operating modes.

Preferably a parameter which can be set and stored by the respective vehicle occupant, in particular by the driver, is used as the at least one individual parameter, wherein the at least one individual parameter changes at least one of the following properties of the reproduction of the visual signal: intensity, brightness, color, color sequence, color nuance and flashing frequency.

The individual adaptation of the reproduction of the visual signal can be, for example, a basically somewhat more intensive or less intensive reproduction of all the signals compared with a standard setting. A more intensive reproduction could be set, for example, for vehicle occupants, in particular, for a driver, with impaired vision. The individual adaptation can also comprise the selection of other colors or color sequences for the different visual signals. It is also conceivable that a plurality of possible colors and/or color sequences are respectively stored for different visual signals, from which a vehicle occupant, in particular the driver, selects a specific color or a specific color sequence for his individual setting. For the operating mode which corresponds to an active electric drive device, the driver can select, for example, from warm colors. The selectable colors are stored as an individual setting for the driver. Such individual settings increase the comfort and also the safety for the driver, in particular according to the aspect that the driver can set colors or color sequences for the corresponding signals which he experiences as pleasant.

According to one embodiment which can be combined with one or more of the embodiments described herein, a parameter which can be set and stored by the respective vehicle occupant is used as the at least one individual parameter (FID1, . . . , FIDn), wherein the at least one individual parameter changes at least one of the following properties of the reproduction of the visual signal: intensity, brightness, color, color sequence, color nuance, flashing frequency.

According to one embodiment which can be combined with one or more of the embodiments described herein, the control system also has a detection device which is coupled to the individual sensor. The detection device is configured to detect the identity of the vehicle occupant and to transmit the detected identity of the vehicle occupant to the individual sensor. The individual sensor is also configured to sense the at least one individual parameter using the detected identity of the vehicle occupant.

Based on the identification of the vehicle occupant, individual settings which are assigned to this vehicle occupant can be considered and the reproduction of visual signals can be correspondingly adapted if it is clear which vehicle occupant is currently operating the vehicle. This can be done, for example, on the basis of data which are exchanged between a transmitter which is carried by a vehicle occupant and a vehicle-side receiver, integrated for example in a vehicle key, which, for example, also serve to release an electronic immobilizer. Settings of the individual parameters can be input and stored by the vehicle occupant, for example, by means of a monitor with an operator control device.

According to a further aspect, the present subject matter also relates to a vehicle having an internal combustion engine and an electric drive device, which vehicle has: a control system according to one of the embodiments described above; and an output device designed to reproduce the visual signal, adapted in accordance with the sensed operating modes, in the passenger compartment of the vehicle.

The above statements to the inventive control system according to the first aspect of the present subject matter also apply correspondingly to the control method according to the second aspect of the present subject matter, and vice versa; advantageous example embodiments of the inventive method correspond to the described advantageous example embodiments of the system according to the present subject matter. Advantageous example embodiments of the method according to the present subject matter which are not explicitly described at this point correspond to the described advantageous example embodiments of the inventive system.

Further advantages, features and details of the present subject matter can be found in the following description of a preferred example embodiment and by reference to the drawing. Features and combinations of features which are specified above in the description and the features and combinations of features which are specified below in the description of the figures and/or shown solely in the figures can be used not only in the respectively indicated combination but also in other combinations or alone without departing from the scope of the present subject matter.

The present subject matter will be described in more detail below by means of example embodiments and with reference to the appended drawings.

### BRIEF DESCRIPTION OF THE DRAWINGS

FIG. 1 shows a schematic view of a control system 1 for adapting the reproduction of visual signals for a vehicle having a hybrid drive.

FIG. 2 shows a simplified flow diagram illustrating a control method for adapting the reproduction of visual signals for a vehicle having a hybrid drive.

### DETAILED DESCRIPTION OF THE DRAWINGS

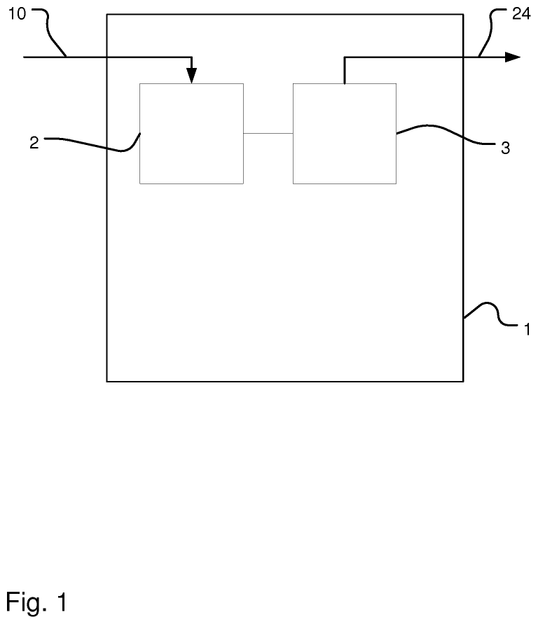

As shown in FIG. 1, the control system 1 has a sensor 2. The sensor 2 senses which operating mode 10 is active, for instance, an operating mode 10 of an internal combustion engine and/or whether an operating mode 10 of an electric drive device is active. The sensor 2 is communicatively connected to an electronic control unit 3. The electronic control unit 3 receives information from the sensor 2 indicating which operating mode 10 is active. The electronic control unit 3 adapts the reproduction 24 of a visual signal in accordance with the sensed operating modes of the internal combustion engine and of the electric drive device.

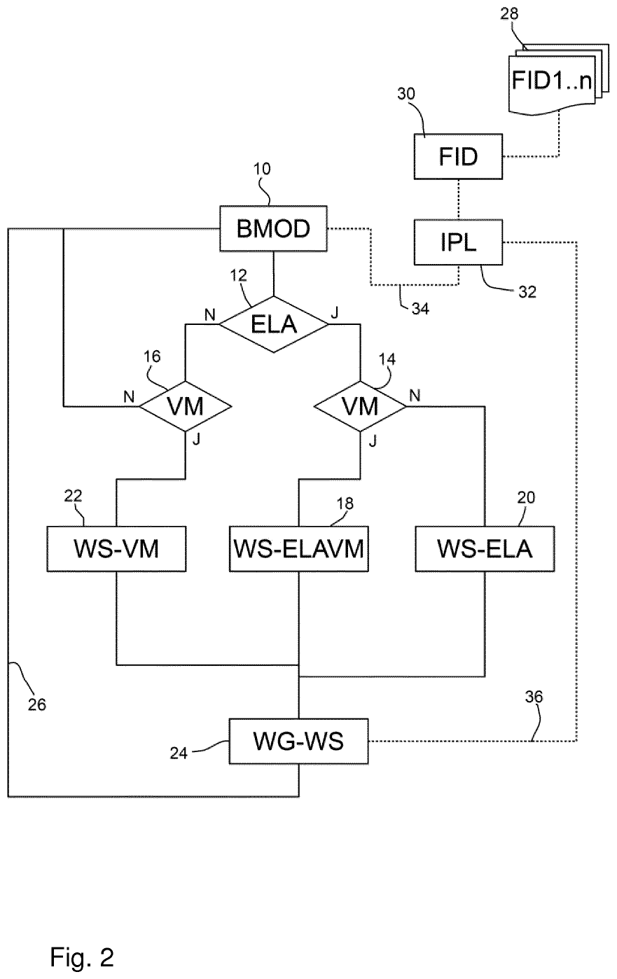

FIG. 2 illustrates by way of example some of the method steps for adapting the reproduction of visual signals in a vehicle having a hybrid drive. Hybrid vehicles may comprise an internal combustion engine (combustion engine) and an electric drive (electric motor) which can be operational individually or together.

In order to be able to output, in changed operating modes of the vehicle or of its two drives, visual signals which can be perceived to an optimum degree by a vehicle occupant, in particular by the driver, for example using special output means (LED) in the dashboard or by means of a combination instrument, CID, ambient light, which can be associated with the passenger compartment lighting equipment of the vehicle, it is possible to proceed according to a control method such as is described below with reference to FIG. 2.

First, at step 10 the operating mode of the two drive units of the internal combustion engine and electric motor is determined. In step 12 it is checked whether the electric drive is activated (ELA). If this is the case, in step 14 it is checked whether the internal combustion engine is also activated (VM). If the internal combustion engine is operational in step 14, at step 18 the setting for the reproduction of the visual signal is selected such that it is optimized for the combined operation of the electric motor and internal combustion engine (WS-ELAVM). If the internal combustion engine is not operational in step 14, it follows that only the electric motor is operational. At step 20, the setting for the reproduction of the visual signal is then selected such that it is optimized for the sole operation of the electric motor (WS-ELA).

If step 10 reveals that the electric motor is not operational, the system continues at step 16 in which it is checked whether the internal combustion engine is operational (VM). If the internal combustion engine is operational in step 16, at step 22 the setting for the reproduction of the visual signal is selected in such a way that it is optimized for the sole operation of the internal combustion engine (WS-VM). If the internal combustion engine is not operational in step 16, it follows from this that none of the two drives is operational and the controller begins again at step 10 (BMOD) or is ended.

The respective settings for the adaptation of the reproduction of the visual signal WS-ELAVM, WS-ELA, WS-VM from the steps 18, 20, 22 are used in step 24 to be able to reproduce at least one visual signal in accordance with the settings (WG-WS), by considering the specific operating mode of the electric and/or internal combustion engine.

It is to be noted that step 24 does not necessarily have to represent the reproduction of a visual signal. Step 24 essentially illustrates that visual signals can be reproduced with the specific settings in accordance with the operating mode if there is a need for their reproduction.

The determination of the operating mode of the electric motor and internal combustion engine is carried out repeatedly during the operation of the vehicle, which is represented by the connection 26 between the steps 24 and 10. This ensures that the reproduction of a visual signal is regularly adapted to the operating modes of the two drive units.

During the adaptation of the reproduction of visual signals, individual parameters can also be considered for a driver of the vehicle. It is to be assumed that individual settings can be stored for each driver (1 to n) of a vehicle by means of data sets FID1 to FIDn, which is illustrated at 28. These data sets can also contain a standard data set which is used if a driver does not wish to store or has not stored any individual settings. The individual parameters which are considered here also relate to the outputting of visual signals. It is therefore possible, for example, to set the type of reproduction, for example a color or a color sequence, individually and store it for a respective driver. Therefore, the one driver can, for example, use a pronounced and striking color nuance for the “sport mode” for himself, while another driver would prefer a somewhat more subtle color nuance for the “sport mode” (e.g. pastel color).

In addition, the intensity can also be set individually. It is also conceivable that a driver would like to set a deviation from a standard intensity so that a visual signal is reproduced in a stronger fashion or more gentle fashion.

If individual parameters of a driver are to be taken into account, in a first step 30 a respective driver is identified (FID). These individual parameters are then assigned to the driver's identity FID1 to FIDn, and they are then taken into account for the operation of the vehicle in accordance with the identified driver, in the present case for the reproduction of visual signals.

In step 32, the individual parameters which are associated with the identified driver, for the reproduction of visual signals, are loaded (IPL) and then input into the reproduction system at a suitable location. This is illustrated by the two dashed lines 34 and 36. Irrespective of the location at which the individual parameters are read in during the method of adapting the reproduction of visual signals, said parameters are used in step 24 when a visual signal is reproduced. As already mentioned above, step 24 represents the provision of at least one visual signal which is adapted to operating modes and/or individual parameters and is reproduced visually in the case of the occurrence of a respective event, such as for example activation of the driving experience switch (sport-eco button) and the like. The individual parameters are generally read in from the associated data sets FID1 to FIDn once at the start of a journey and then used until the journey is ended and the driver leaves his vehicle. If a driver has not stored any individual parameters for himself, standard parameters are used, which are usually stored in one of the data sets FID1 to FIDn if no individual changes have been made to them.

1-10. (canceled)

11. A control system for adapting a reproduction of visual signals for a vehicle having a hybrid drive, comprising:
a sensor to sense an operating mode of an internal combustion engine and of an electric drive of the vehicle; and
an electronic control unit coupled to the sensor and configured to adapt the reproduction of a visual signal in accordance with the sensed operating modes of the internal combustion engine and the electric drive.

12. The control system according to claim 11, wherein
the visual signal comprises at least one of:
an indication of the current driving experience mode,
vehicle passenger compartment lighting,
warning signal,
navigation display,
infotainment display,
road sign detection display,
steering wheel lighting,
combination instrument display,
keypad lighting,
status display of a driving assistance system, or
parking distance indication.

13. The control system according to claim 11, wherein
the adaptation of the reproduction of the visual signal comprises changing at least one of the following properties of the visual signal:
intensity,
brightness,
color,
color sequence,
color nuance, or
flashing frequency.

14. The control system according to claim 13, wherein
in response to the internal combustion engine operating alone or in addition to the electric drive, the at least one of the properties of the visual signal is changed in at least one of the following ways:
increasing or reducing the intensity;
increasing or reducing the brightness;
changing the color;
changing the color sequence;
changing the color nuance; or
increasing or reducing the flashing frequency.

15. The control system according to claim 11, wherein the control system further comprises:
an individual sensor coupled to the electronic control unit to sense at least one individual parameter assigned to a vehicle occupant, wherein
the electronic control unit is further configured to adapt the reproduction of the visual signal in accordance with the at least one individual parameter of the vehicle occupant.

16. The control system according to claim 15, wherein
the at least one individual parameter is suitable for defining the adaptation of the reproduction of the visual signal and for adding to or replacing the adaptation in accordance with the sensed operating modes.

17. The control system according to claim 15, wherein
a parameter that can be set and stored by the respective vehicle occupant is used as the at least one individual parameter, wherein
the at least one individual parameter changes at least one of the following properties of the reproduction of the visual signal:
intensity,
brightness,
color,
color sequence,
color nuance, or
flashing frequency.

18. The control system according to claim 15, wherein the control system further comprises:
a detection device coupled to the individual sensor and configured to:
detect the identity of the vehicle occupant, and
transmit the detected identity of the vehicle occupant to the individual sensor, wherein
the individual sensor is further configured to sense the at least one individual parameter using the detected identity of the vehicle occupant.

19. A vehicle having an internal combustion engine and an electric drive, comprising:
the control system of claim 11; and
an output device to reproduce, in the passenger compartment of the vehicle, the visual signal that has been adapted in accordance with the sensed operating modes.

20. A control method for adapting a reproduction of visual signals for a vehicle having a hybrid drive, comprising:
sensing an operating mode of an internal combustion engine and of an electric drive device of the vehicle; and
adapting the reproduction of a visual signal in accordance with the sensed operating modes of the internal combustion engine and of the electric drive device.
